(19) United States
(12) Patent Application Publication
(10) Pub. No.: US 2015/0367567 A1
(43) Pub. Date: Dec. 24, 2015

(54) HAND-HELD APPARATUS FOR THE TRANSVERSE WELDING OF A TUBE

(71) Applicant: Fresenius Kabi Deutschland GmbH, Bad Homburg (DE)

(72) Inventors: Martin Biehl, St. Wendel (DE); Detlef Hertel, Frankfurt (DE); Christen Halter, Hanau (DE); Johannes Rasche, Darmstadt (DE); Marcel Kieser, Darmstadt (DE); Marc Franosch, Darmstadt (DE)

(21) Appl. No.: 14/762,504

(22) PCT Filed: Jan. 6, 2014
(86) PCT No.: PCT/EP2014/050088

§ 371 Date: Jul. 22, 2015

Related U.S. Application Data
(60) Provisional application No. 61/756,648, filed on Jan. 25, 2013.

(30) Foreign Application Priority Data
Jan. 24, 2013 (EP) 13152539.6

(51) Int. Cl. B29C 65/00; B29C 65/78; B29C 65/04

(52) U.S. Cl. CPC B29C 66/5221; B29C 65/04; B29C 65/7841; B29C 66/0326

(57) ABSTRACT

A hand-held device for the transverse welding of plastic tubes, comprising a welding device for the transverse welding of a tube and a separating device for completely separating the transverse-welded tube on the transverse welding.

The present invention relates to a hand-held apparatus for the transverse welding of plastic tubes.

DE4014037C1 discloses a hand-held apparatus for the stated purpose. The hand-held apparatus comprises a welding device made up of two electrodes, by means of which a tube can be transversely welded, a squeezing device, by means of which any liquid that may be present is forced out of the welding area before welding by squeezing the tube together, and a separating device, which makes it possible for the tube to be separated into a first tube portion and a second tube portion. According to one embodiment of the hand-held apparatus, the separating device is to have a cutting edge, by means of which the tube can be separated or provided with a predetermined tear line.

The hand-held apparatus according to the invention for the transverse welding of plastic tubes comprises a welding device for the transverse welding of a tube and a separating device for the complete separation of the transversely welded tube at the transverse welding. This allows the elimination of a subsequent working step for separating the tubes, to be carried out manually, as is customary at present. In this way it is possible to shorten the welding and separating procedure and make the task less arduous for an operator.

The hand-held apparatus is preferably designed as a hand-held apparatus for the transverse welding of a plastic tube filled with a medium. The medium may for example be a biological or infectious medium. With particular preference, the hand-held apparatus is designed for the transverse welding of plastic tubes filled with blood, such as are used in the area of transfusion, for example for blood bag systems. Customary materials for such plastic tubes are PVC, PU or EVA.

According to one embodiment, the separating device is designed in such a way that the separation is performed mechanically. Within the scope of the invention, apart from other mechanical separating processes, mechanical separation is intended to comprise cutting, punching and tearing. As an alternative or in addition, apart from mechanical separation, other types of separating processes may also be used, for example processes that work with heat or with air pressure.

According to a further embodiment, the separating device comprises at least one gripping element, the gripping element gripping a first tube portion and moving it away from a second tube portion to perform the separation, the first tube portion lying on one side and the second tube portion lying on the other side of the transverse welding. The term “gripping” is intended within the scope of the invention also to comprise processes such as “seizing”, “securely holding”, “clamping” and “contacting”. What is important is that the gripping element can actively move the first tube portion away from the second tube portion, and consequently a separation of the tube can be brought about at the transverse welding.

In a variant, two gripping elements are provided, respectively moving a tube portion for the purpose of separating the tube.

According to a further embodiment, the hand-held apparatus is designed in such a way that it can be transferred from a starting position, in which a tube can be placed into the hand-held apparatus, into a first actuating position, in which the transverse welding of the tube placed in is performed by the welding device, and into a second actuating position, which follows the first actuating position and in which a separation of the tube is performed by the separating device. The transverse welding and/or the separation of the tube may be performed in the first actuating position or the second actuating position and/or during the transfer from the starting position into the first actuating position or during the transfer from the first actuating position into the second actuating position. The hand-held apparatus is preferably designed in such a way, for example by means of a spring mechanism, that the hand-held apparatus can return to the starting position of its own accord. The term “can be placed” comprises in the broader sense the positioning of the tube to be welded and to be separated in or on the hand-held apparatus.

The hand-held apparatus may comprise a blocking device, which in a blocking position blocks a transfer from the first actuating position into the second actuating position. The purpose is to prevent the tube from being separated before the welding operation has been completed.

The blocking device may comprise a manual and/or automatic actuating element, by means of which the blocking device can be transferred from the blocking position into a non-blocking position, in which the transfer from the first actuating position into the second actuating position is no longer blocked. A manual actuating element may for example be a switch, button or lever, by means of which the blocking device can be operated. As an alternative, the blocking device may be designed in such a way that repeated pressing or two-stage pressing is necessary to arrive in the second actuating position. An automatic actuating element may for example comprise a control unit, which checks the completion of the welding operation and/or waits for a sufficient time for the welding operation and then automatically cancels the blocking position.

In a further embodiment, the hand-held apparatus additionally comprises a holding device for holding at least the first tube portion in a holding position after the separation of the tube by the separating device. The purpose is for example to prevent one or both tube portions from falling to the ground after the separating operation has been completed. The holding device may be integrated as an independent device or be completely or partially integrated in one of the other devices, for example in the separating device and/or the welding device.

According to one embodiment, the hand-held apparatus is designed for being operated with a single hand.

The invention is explained in more detail below on the basis of exemplary embodiments, which are represented by a number of figures, in which:

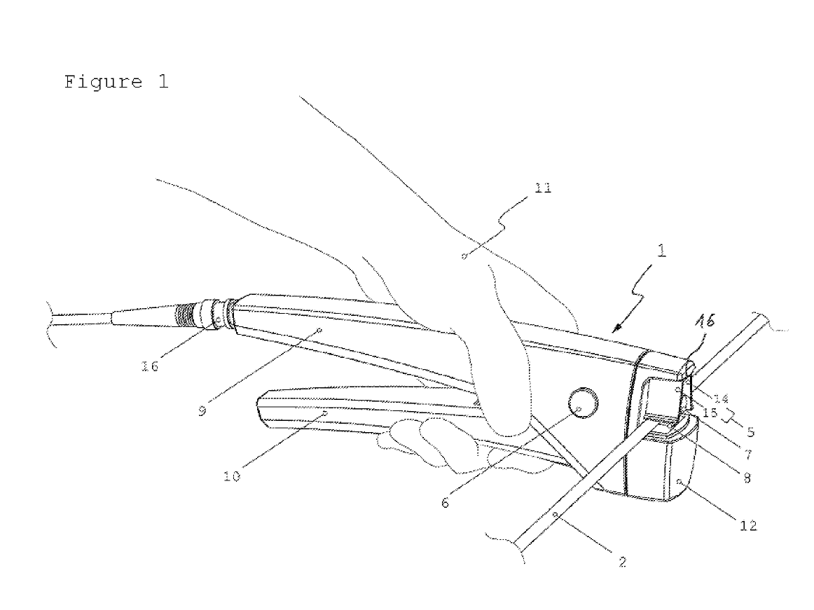

FIG. 1 shows a perspective view of a hand-held apparatus according to a first embodiment,

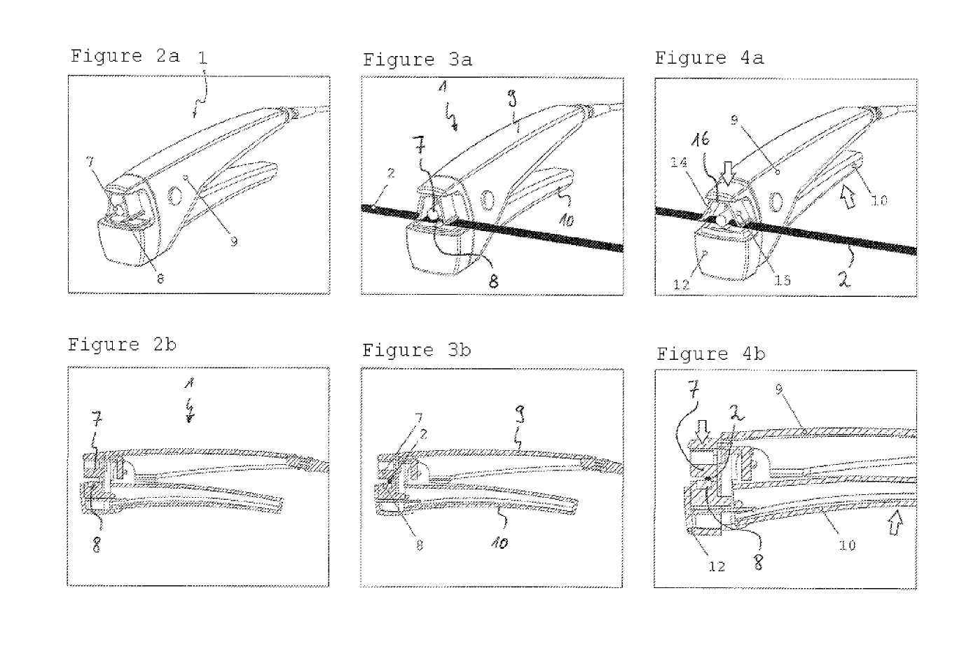

FIGS. 2-7 show a sequence of the individual method steps from the placing of a tube into the hand-held apparatus according to the first embodiment to the return of the hand-held apparatus to its starting position,

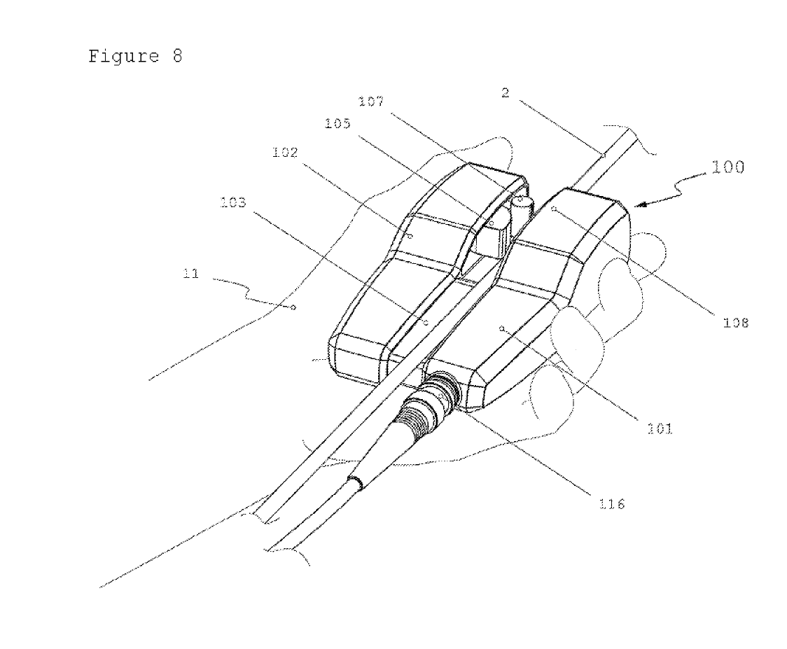

FIG. 8 shows a perspective view of a hand-held apparatus according to a second embodiment,

FIGS. 9-14 show a sequence of the individual method steps from the placing of a tube into the hand-held apparatus according to the first embodiment to the return of the hand-held apparatus to its starting position.

FIG. 1 shows a perspective view of a hand-held apparatus 1 according to a first embodiment of the invention.

Here, the hand-held apparatus 1 is a hand-held apparatus for the transverse welding and separation of plastic tubes filled with blood, as are customarily used in transfusion, for example in blood bag systems. The hand-held apparatus is designed in such a way that the handling and actuation of the hand-held apparatus 1 is possible with a single hand 11. For this purpose, the hand-held apparatus 1 comprises a body 9, a grip 10 and an actuating element 6, here a button. Furthermore, the hand-held apparatus comprises a welding device with a first electrode 7 and a second electrode 8, a connection 16 for the power supply of the welding device, and also a separating device with a gripping element 5 and a slide 12, which is movable with respect to the body 9.

The welding device is designed as a welding device that is known in principle to a person skilled in the art, with the first electrode 7 as a cold electrode and the second electrode 8 as a warm electrode. The warm electrode 8 is arranged fixedly with respect to the body 9, while the cold electrode 7 is movable in relation to the body 9, and consequently in relation to the warm electrode 8, as a result of being fastened to the slide 12. This makes it possible for a tube 2 to be placed between the two electrodes, and for the tube 2 to be pinched to displace liquid that may be present in the tube in the welding area and for transverse welding of the tube 2 to be performed after the displacement of the liquid. Since it is known in principle to a person skilled in the art, the welding device has not been depicted in any more detail in the figures shown here for the purpose of better overall clarity.

The gripping element 5 is likewise arranged on the slide that is movable with respect to the warm electrode 8. The gripping element 5 is designed in the form of an A-shaped clamp and comprises a first leg 14 and a second leg 15, which are respectively arranged on opposite sides of the cold electrode 7. The legs 14 and 15 converge above the cold electrode 7 in a base 16 on the side that is facing away from the warm electrode 8. The gripping element 5 consists of an elastically deformable material, for example of an elastic plastic. The legs 14 and 15 are only fixed to the slide 12 at the base 16, whereby the legs 14 and 15 can be resiliently spread outward.

As represented in the subsequent FIGS. 2-7 and explained in more detail further below, the function of the gripping element 5 is not just that of completely separating the tube 2 into two tube portions 3, 4, but also that of holding the two tube portions 3, 4 after the separation of the tube 2. The separating device and the holding device are consequently configured here in a single device.

FIGS. 2-7 show a sequence of the individual method steps from the placing of a tube into the hand-held apparatus 1 to the return of the hand-held apparatus 1 to its starting position. FIGS. 2a-7a thereby show the sequence in perspective views; FIGS. 2b-7b show the various operating states in a cross-sectional view of the hand-held apparatus 1.

FIGS. 2a and 2b show the hand-held apparatus 1 in its starting position. Between the electrodes 7, 8 there is a sufficiently wide gap to allow a tube 2 that is to be welded and separated to be placed in. The electrodes 7 and 8 are arranged parallel to one another and in the longitudinal direction on the front side of the body 9, so that the tube 2 is conveniently gripped transversely by the hand-held apparatus 1 or the tube 2 can be placed in transversely between the electrodes 7, 8.

FIGS. 3a and 3b show the state after the tube 2 has been placed into the hand-held apparatus.

After the placing in of the tube 2, the grip 10 is pulled in the direction of the body 9, as represented in FIGS. 4a and 4b. The grip 10 transfers the movement to the slide 12, and consequently to the cold electrode 7, which moves toward the warm electrode 8. Liquid located in the tube 2 in the area of the welding location is displaced and the welding operation (transverse welding of the tube 2) is carried out. The hand-held apparatus is in a first actuating position. Further pulling of the grip 10 is initially blocked by a blocking device 13 in a blocking position (shown in FIG. 5b), which for the user represents a first stop.

After completion of the welding operation, the blocking device is transferred from the blocking position into a non-blocking position by pressing the actuating element 6, see FIGS. 5a and 5b. In this exemplary embodiment, the cold electrode 7 is spring-mounted with respect to the slide, the spring action being blocked in the blocking position, that is to say the cold electrode 7 assumes a fixed position in relation to the slide 12, and consequently further movement of the slide 12 and of the grip 10 is no longer possible after the squeezing together of the tube 2. By actuating the actuating element 6, the fixing of the cold electrode 7 to the slide 12 is released, so that the cold electrode 7 can spring in relation to the slide 12, and in this way the blocking of the further movement of the grip 10 is discontinued. The cold electrode 7 is prestressed in the direction of the warm electrode 8, so that in the non-blocking position the cold electrode 7 remains lying on the welding location.

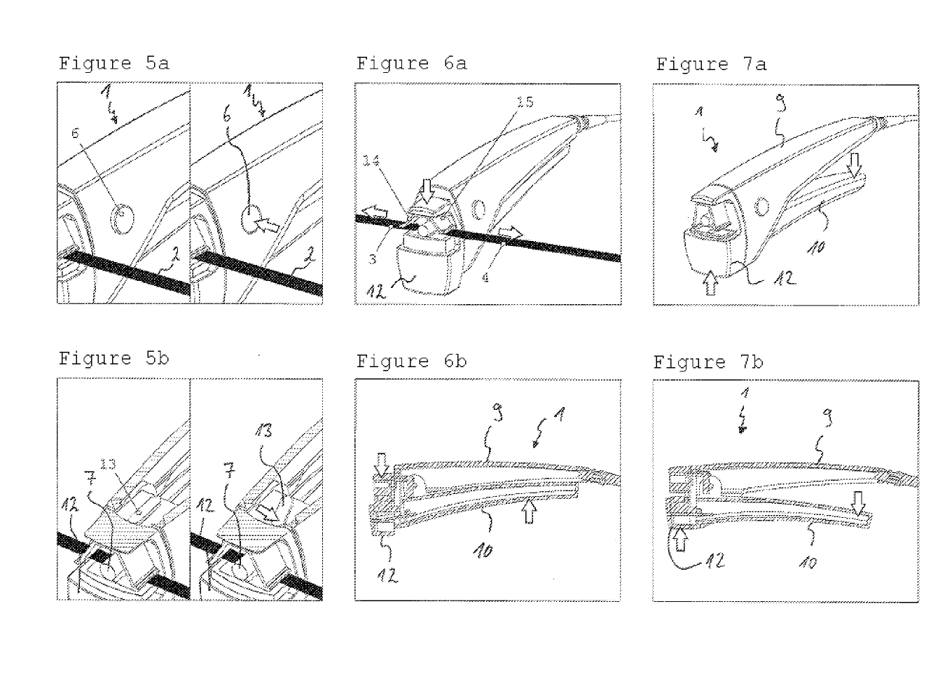

By further pressing of the grip 10 in the direction of the body 9 up to a second stop, the hand-held apparatus 1 is transferred into a second actuating position, see FIGS. 6a and 6b. Already during the transfer into the first actuating position, see FIGS. 4a, 4b, the legs 14, 15 of the gripping element 5 have come to lie against the first tube portion 3 on the left side and against the second tube portion 4 on the right side of the welding location; the gripping element 5 is slightly spread. By the further pressing of the grip 10, and the accompanying further spreading of the A-shaped gripping element 5, the legs 14, 15 push the respective tube portions 3, 4 apart in opposite directions, until finally a severing of the tube 2 takes place at the welding location before the second actuating position is reached. After the severing of the tube 2, the legs 14, 15 securely hold the respective tube portion 3, 4, assisted by the restoring force that has built up during the spreading on account of the elasticity of the gripping element 5.

By letting go of the grip 10 or by relaxing the pressure, the grip 10 returns to its starting position under the action of a spring mechanism that is not represented in any more detail, see FIGS. 7a, 7b. The return of the grip 10 to the starting position has the effect that the hand-held apparatus 1 as a whole also returns to its starting position; in particular, the slide 12, the electrode 7, the blocking device 13 and the gripping element 5 move back to the respective starting position. The two tube portions 3, 4 are no longer held by the gripping element 5; the two tube portions 3, 4 welded at their respective end can be removed. The hand-held apparatus 1 can be used once again.

FIG. 2 shows a perspective view of a hand-held apparatus 100 according to a second embodiment of the invention.

Here, the hand-held apparatus 100 is a hand-held apparatus for the transverse welding and separation of plastic tubes filled with blood, as are customarily used in transfusion, for example in blood bag systems. The hand-held apparatus 100 is designed in such a way that the handling and actuation of the hand-held apparatus 100 is possible with a single hand 11. For this purpose, the hand-held apparatus 100 comprises a first housing half 101 and a second housing half 102, which are oppositely arranged and leave between them a gap 103 for the placing in of a tube 2 that is to be transversely welded and separated. The two housing halves 101 and 102 can be grasped with the hand 11; the actuation of the hand-held apparatus 100 is performed by pressing the housing halves 101, 102 together.

The hand-held apparatus 100 comprises a welding device for the transverse welding, with a cold electrode 107 and a warm electrode 108, and also a separating device, with a gripping element 105, here a pivoting jaw 105. The power supply to the welding device takes place by way of a connection 116. The electrodes 107, 108 and the pivoting jaw 105 are arranged in the region of the gap 103, so that they can act on a tube 2 positioned in the gap 103.

FIGS. 9-14 show a sequence of the individual method steps from the placing of a tube into the hand-held apparatus 100 to the return of the hand-held apparatus 100 to its starting position. FIGS. 9a-14a thereby show the sequence in perspective views; FIGS. 9b-14b show the various operating states in a cross-sectional view of the hand-held apparatus 100. For the purpose of overall clarity, only the relevant elements of the welding device and the separating device are shown.

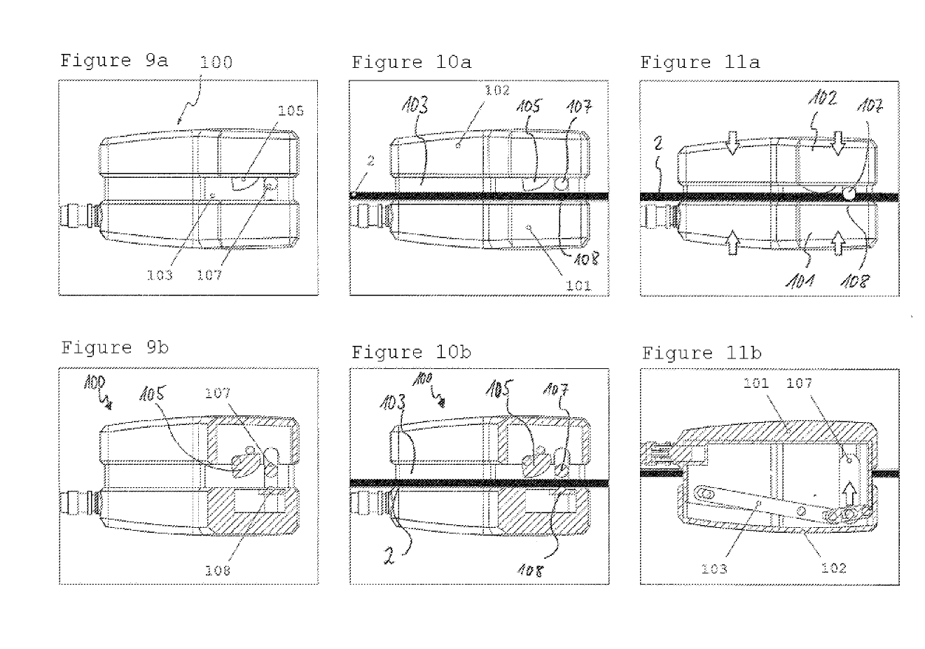

FIGS. 10a, 10b show the hand-held apparatus 100 in its starting position. While leaving a sufficiently large gap for the placing in of the tube 2, the cold electrode 107 and the warm electrode 108 are arranged such that they are aligned parallel to one another in the gap 103 of the hand-held apparatus 100. Furthermore, the alignment of the electrodes is perpendicular to the line followed by the gap 103 and perpendicular to the surface of the housing halves 101, 102, which makes it possible for the tube 2 to be placed in from the side or gripped from the side and for transverse welding of the tube 2 to be performed.

After placing in the tube 2, the hand-held apparatus 100 is pressed together slightly. The movable cold electrode 107, which is in operative connection with the second housing half 102 by way of a lever mechanism 104, see FIG. 11b, is moved by the pressing together of the housing halves 101, 102 in the direction of the warm electrode 108, which is fixedly connected to the first housing half 101, until the tube 2 is gripped by the two electrodes 107, 108.

This is followed by further pressing together of the two housing halves 101 and 102 up to a first stop, which marks a first actuating position. The first stop is defined by the cold electrode 107 no longer being able to be moved any further after squeezing of the tube 2 on account of the fixed warm electrode 108. Shortly before reaching the first fixed point, the RF welding of the tube 2 is activated by a dry-reed switch, and in this way the transverse welding of the tube 2 is initiated.

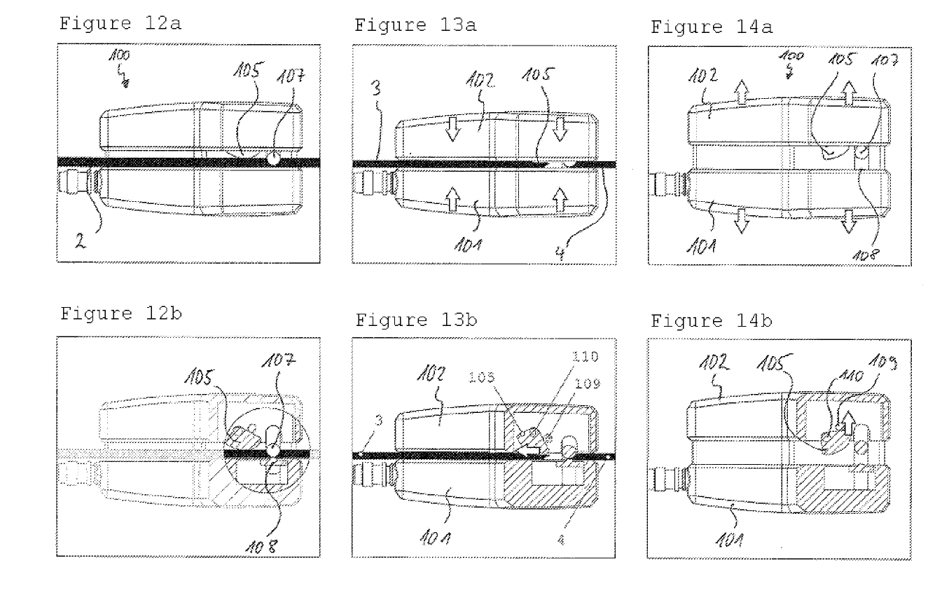

Further pressing together of the housing halves 101, 102 is initially blocked on account of the position of the cold electrode 107. Pressing of a lateral pushbutton that is not represented in any more detail has the effect that an unlocking mechanism with a mechatronic means that is not represented in any more detail (mechanical, optionally electromechanical) unlocks the cold electrode 107, which can resiliently yield in relation to the warm electrode 108 and in relation to the second housing half 102 by means of a spring mechanism that is not represented in any more detail of the welding device, the spring mechanism being designed in such a way that the cold electrode 107 remains lying with prestress on the welding location, see FIGS. 12a, 12b. The mechatronic means consequently form a blocking device, which in a blocking position (cold electrode locked) initially blocks the transfer from the first actuating position into a subsequent, second actuating position, and, by cancelling the blocking position, that is to say in a non-blocking position (cold electrode unlocked), makes the transfer into the second actuating position possible.

After cancelling of the blocking position, the two housing halves 101, 102 are pressed further together, see FIGS. 13a, 13b. The pivoting jaw 105 is connected to the first housing half 101 pivotably about an axis 110 aligned parallel to the electrodes, the pivoting jaw 105 being mounted eccentrically. The hand-held apparatus 100 has a pin 109 fixedly connected to the second housing half 102. By pressing the two housing halves together, see FIG. 12b, the pin 109 comes to lie on the side of the pivoting jaw 105 that is facing away from the warm electrode 108 and, when the housing halves 101, 102 are pressed further together, it deflects the eccentrically mounted pivoting jaw 105 in the direction of the tube 2 and away from the two electrodes 107, 108. In its turning movement, the pivoting jaw 105 engages the tube 2 and pulls the first tube portion 3 of the tube 2, lying to the right of the welding location, away from the second tube portion 4 of the tube 2, lying to the left of the welding location, until finally a separation of the tube takes place at the welding location. A stop that prevents further pressing together of the two housing halves 101, 102 marks a second actuating position of the hand-held apparatus 100.

In the second actuating position, the first tube portion 3 is held by the pivoting jaw 105 acting together with the first housing half 101 and the second tube portion 4 is held by the two electrodes 107, 108. The separating device and the welding device consequently form a holding device for holding the two tube portions 3, 4; the second actuating position is as it were a holding position.

By relaxing or discontinuing the pressure on the two housing halves, see FIGS. 14a, 14b, the hand-held apparatus 100 goes back into its starting position, here of its own accord by means of a spring mechanism that is not represented in any more detail. The pivoting jaw 105, which is likewise prestressed into its non-deflected starting position, pivots back; the electrodes 107, 108 move apart, whereby the two tube portions 3, 4 are released for removal. The cold electrode 107 is locked. The hand-held apparatus 100 is available for renewed use.

1. A hand-held apparatus for the transverse welding of plastic tubes, comprising a welding device for the transverse welding of a tube and a separating device for the complete separation of the transversely welded tube at the transverse welding.

2. The hand-held apparatus as claimed in claim 1, the separating device being designed in such a way that the separation is performed mechanically.

3. The hand-held apparatus as claimed in claim 2, the separating device being designed in such a way that a first tube portion of the tube is moved away from a second tube portion of the tube to perform the separation of the tube, such that the first tube portion lies on one side and the second tube portion lies on the other side of the transverse welding.

4. The hand-held apparatus as claimed in claim 3, the separating device comprising at least one gripping element, the gripping element configured to grip the first tube portion and move the first tube portion away from the second tube portion to perform the separation.

5. The hand-held apparatus as claimed in claim 1, the hand-held apparatus being designed in such a way that it can be transferred from a starting position, in which a tube can be placed into the hand-held apparatus, into a first actuating position, in which the transverse welding of the tube placed in is performed by the welding device, and into a second actuating position, which follows the first actuating position and in which a separation of the tube is performed by the separating device.

6. The hand-held apparatus as claimed in claim 5, comprising a blocking device, which in a blocking position blocks a transfer from the first actuating position into the second actuating position.

7. The hand-held apparatus as claimed in claim 6, wherein the blocking device comprises a manual and/or automatic actuating element, by means of which the blocking device can be transferred from the blocking position into a non-blocking position, in which the transfer from the first actuating position into the second actuating position is no longer blocked.

8. The hand-held apparatus as claimed in claim 1, additionally comprising a holding device for holding at least the first tube portion in a holding position after the separation of the tube by the separating device.

9. The hand-held apparatus as claimed in claim 8, the separating device comprising at least one gripping element, the gripping element configured to grip the first tube portion and move the first tube portion away from the second tube portion to perform the separation, the gripping element being designed in such a way that, at least as part of the holding device, holds the first tube portion after the separation of the tube.

10. The hand-held apparatus as claimed in claim 8, the hand-held apparatus being designed in such a way that it can be transferred from a starting position, in which a tube can be placed into the hand-held apparatus, into a first actuating position, in which the transverse welding of the tube placed in is performed by the welding device, and into a second actuating position, which follows the first actuating position and in which a separation of the tube is performed by the separating device, the holding device being designed in such a way that, when the hand-held apparatus returns to its starting position, said holding device returns from a holding position, in which at least the first tube portion is held, to its original position, in which the holding of at least the first tube portion is discontinued.

11. The hand-held apparatus as claimed in claim 1, the hand-held apparatus being designed in such a way that it can be operated with a single hand.

12. The hand-held apparatus as claimed in claim 1, the welding device comprising at least a first electrode and a second electrode for the electrode welding of the tube.

13. The hand-held apparatus as claimed in claim 12, the first electrode and the second electrode being arranged movably in relation to one another for the squeezing of the tube before the welding operation.

14. The hand-held apparatus as claimed in claim 2, the hand-held apparatus being designed in such a way that it can be transferred from a starting position, in which a tube can be placed into the hand-held apparatus, into a first actuating position, in which the transverse welding of the tube placed in is performed by the welding device, and into a second actuating position, which follows the first actuating position and in which a separation of the tube is performed by the separating device.

15. The hand-held apparatus as claimed in claim 3, the hand-held apparatus being designed in such a way that it can be transferred from a starting position, in which a tube can be placed into the hand-held apparatus, into a first actuating position, in which the transverse welding of the tube placed in is performed by the welding device, and into a second actuating position, which follows the first actuating position and in which a separation of the tube is performed by the separating device.

16. The hand-held apparatus as claimed in claim 4, the hand-held apparatus being designed in such a way that it can be transferred from a starting position, in which a tube can be placed into the hand-held apparatus, into a first actuating position, in which the transverse welding of the tube placed in is performed by the welding device, and into a second actuating position, which follows the first actuating position and in which a separation of the tube is performed by the separating device.

17. The hand-held apparatus as claimed in claim 2, comprising a holding device for holding at least the first tube portion in a holding position after the separation of the tube by the separating device.

18. The hand-held apparatus as claimed in claim 3, comprising a holding device for holding at least the first tube portion in a holding position after the separation of the tube by the separating device.

19. The hand-held apparatus as claimed in claim 2, the hand-held apparatus being designed in such a way that it can be operated with a single hand.

20. The hand-held apparatus as claimed in claim 2, the welding device comprising at least a first electrode and a second electrode for the electrode welding of the tube.
